(19) United States
(12) Patent Application Publication
(10) Pub. No.: US 2013/0125360 A1
(43) Pub. Date: May 23, 2013

(54) DEVICE HAVING A SPHERICAL ELEMENT TO BE CRIMPED, CRIMPING METHOD AND CRIMPING SYSTEM

(71) Applicants: Thomas Boivin, La Thuile (FR); Patrick Lejars, St Alban de Montbel (FR)

(72) Inventors: Thomas Boivin, La Thuile (FR); Patrick Lejars, St Alban de Montbel (FR)

(73) Assignee: BOLLHOFF OTALU S.A., La Ravoire (FR)

(21) Appl. No.: 13/813,789

(22) PCT Filed: Aug. 2, 2011
(86) PCT No.: PCT/FR11/00453

§ 371 Date: Feb. 1, 2013

(30) Foreign Application Priority Data
Aug. 5, 2010 (FR) 10 03285

(51) Int. Cl. B23P 11/00

(52) U.S. Cl. CPC B23P 11/00
USPC 29/283.5; 29/505

(57) ABSTRACT

The crimping system for a device having a spherical element to be crimped comprising a stem mounted in a sleeve and ended at one end with the spherical element, comprises:
an anvil intended to bear on a bearing flange of the sleeve,
means of traction comprising a system of jaws configured to enclose the spherical element.

### TECHNICAL FIELD OF THE INVENTION

The invention relates to a device having a spherical element to be crimped comprising a stem ending at a first end with a spherical element. The invention also relates to the associated crimping method and crimping system.

### STATE OF THE ART

A device having a spherical element comprises a stem equipped at a first end with the spherical element having, for example, the shape of a ball.

A first example of such a device having a spherical element is illustrated in FIG. 1 and comprises a stem 1 successively provided along the longitudinal axis A1 of the stem with a spherical element 2, a bearing element 3, and a cylinder 4. This device having a spherical element is intended to be crimped onto a plate comprising a through hole, the end of the stem formed by the cylinder 4 is inserted into the hole in the plate until the bearing element 3 comes into contact with the plate. The dimensions of the hole in the plate is complementary to those of the cylinder 4 of the stem 1 so that the bearing element 3 abuts against the plate. Then, the cylinder 4 is deformed so as to form a bead whose dimensions are superior to the diameter of the through bore in the plate, and thus to crimp the device having a spherical element onto the plate. This technique presents the disadvantage of requiring the access to the two opposite sides of the plate where the device must be crimped, a first side being used for inserting the device, and a second side allowing the deformation of the stem of the device in order to crimp it.

A second example of such a device having a spherical element is illustrated in FIG. 2. This device having a spherical element differs from that in FIG. 1 in that the cylinder 4 of the stem 1 is threaded. This thread makes it possible to fix the device having a spherical element to a nut once inserted into a hole in the plate. This technique presents the disadvantage of requiring several steps for the operator having to fix the device having a spherical element, in addition to an access to the two sides of the plate.

Moreover, screwing is not as reliable as crimping as regards mechanical resistance, For example, if the device having a spherical element is screwed on a bolt on a plate subjected to important vibrations, it can result in an undesired unscrewing of the device having a spherical element, and thus in the dissociation of the device having a spherical element from the plate.

Devices having a spherical element are used in many fields. They are found at the fixation interfaces for jacks used for facilitating the opening of elements such as car hatchbacks, doors, trunks, etc.

### OBJECT OF THE INVENTION

The objective of the invention is to provide a device having a spherical element whose assembly can be carried out blindly, i.e. without having to access to the two sides of the plate to which said device having a spherical element must be fixed.

This objective is reached by the annexed claims and in particular in that the device comprises a sleeve into which the stem is inserted, said sleeve successively including along its longitudinal axis:
an assembling area for assembling the sleeve on the stem,
a recessing area intended to the formation of a crimping bead, and
a bearing flange, the spherical element of the stem projecting at the bearing flange.

The invention also relates to a crimping method for crimping a device having a spherical element with a support comprising a hole. The method comprises the following steps of:
inserting the device having a spherical element into the hole in the support, through its end opposite the spherical element until the bearing flange comes into contact with the support,
crimping the device by applying a holding force so that the bearing flange presses on the support, while applying a traction to the spherical element so as to deform the sleeve in the recessing area in order to form a bead.

The invention also relates to a crimping system for a device having a spherical element to be crimped comprising a stem mounted in a sleeve and ended at one end with the spherical element, said system comprises:
an anvil intended to bear on a bearing flange of the sleeve,
means of traction comprising a system of jaws configured to enclose the spherical element.

### BRIEF DESCRIPTION OF THE DRAWINGS

Other advantages and features will more clearly arise from the following description of particular embodiments of the invention given as nonrestrictive examples and represented in the annexed drawings, in which:

FIGS. 1 and 2 illustrate two types of distinct devices having a spherical element according to prior art.

FIG. 3 illustrates a sectional view of a device having a spherical element according to an embodiment of the invention.

FIG. 4 illustrates a stem having a spherical element as used in the device in FIG. 3.

FIGS. 5 and 6 respectively illustrate another embodiment of the device having a spherical element and its associated stem.

FIG. 7 illustrates a step of a crimping method for crimping the device having a spherical element in FIG. 3 onto a support.

FIG. 8 illustrates the device having a spherical element placed on a support once crimped.

FIG. 9 illustrates a three-dimensional view of a crimping system for a device to be crimped, in which one jaw of the means of traction and a moving part of the anvil have been removed.

FIG. 10 illustrates a three-dimensional view of the crimping system in FIG. 9 in which the removed jaw has been added.

FIG. 11 illustrates a view centered on a jaw of the crimping system.

FIG. 12 illustrates a three-dimensional view of the crimping system in FIG. 10 in which the moving part of the anvil has been added.

FIG. 13 illustrates a locking element mounted on the body of the anvil in FIG. 12.

FIG. 14 schematically illustrates two jaws of the means of traction in an open position.

FIG. 15 schematically illustrates two jaws of the means of traction in a closed position.

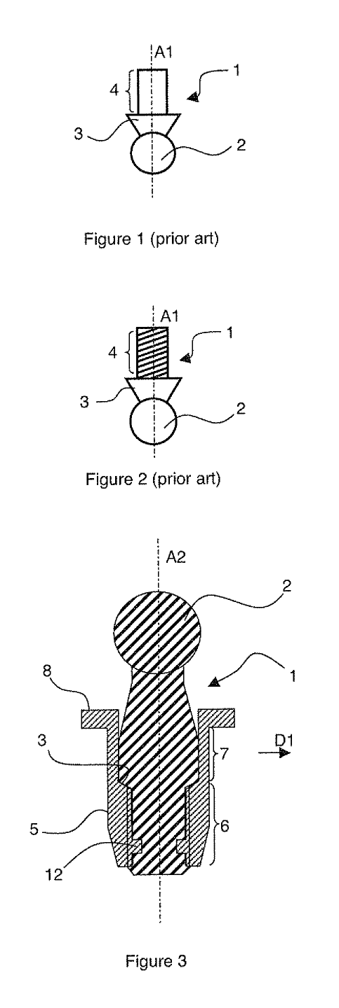

### DESCRIPTION OF PREFERENTIAL EMBODIMENTS

In FIGS. 3 to 6, the device having a spherical element to be crimped comprises a stem 1 ended with a spherical element 2. This stem 1 is mounted, preferably at a second end opposite the spherical element 2, onto a sleeve 5 whose body has a deformable part. Preferably, the sleeve 5 forms a barrel open at its two distal ends along its longitudinal axis A2, said longitudinal axis A2 being then collinear with the axis of the through or unthrough hole forming the sleeve 5.

The stem 1 is inserted into the sleeve 5. The sleeve 5 successively includes along its longitudinal axis A2 (FIGS. 3 and 5) an assembling area 6 for assembling the sleeve 5 onto the stem 1, a recessing area 7, and a bearing flange 8. The bearing flange 8 preferably projects on the entire external perimeter of the sleeve 5. The spherical element 2 of the stem 1 projects out of the sleeve 5 at the bearing flange 8. In other words, the sleeve 5 comprises at one of its ends the bearing flange 8, and the spherical element 2 projects out of the flange 8 in a direction substantially parallel to the longitudinal axis A2 of the sleeve 5 so that the spherical element can be gripped.

The recessing area 7 is intended for the formation of a crimping bead, it is thus deformable. In other words, the recessing area 7 can be made out of a material more malleable than that forming the assembly area 6 and the bearing flange 8. According to a preferred particular case, illustrated in FIGS. 3 and 5, the sleeve 5 is formed out of only one material. In this case, the material thickness in the recessing area 7, in a direction D1 perpendicular to the longitudinal axis A2 of the sleeve 5, and according to the revolution of D1 about the longitudinal axis A2 of the sleeve 5, can be inferior to the material thickness in the other areas of the sleeve 5 (flange 8 and assembly area 9) in the direction D1 and according to its revolution around the axis A2.

The stem 1 and the sleeve 5 are preferably made out of a material chosen among steel, stainless steel, aluminum or brass.

The sleeve 5 can be assembled with the stem in the assembling area 6 for example by welding, friction fitting, swaging, or snap riveting the sleeve 5.

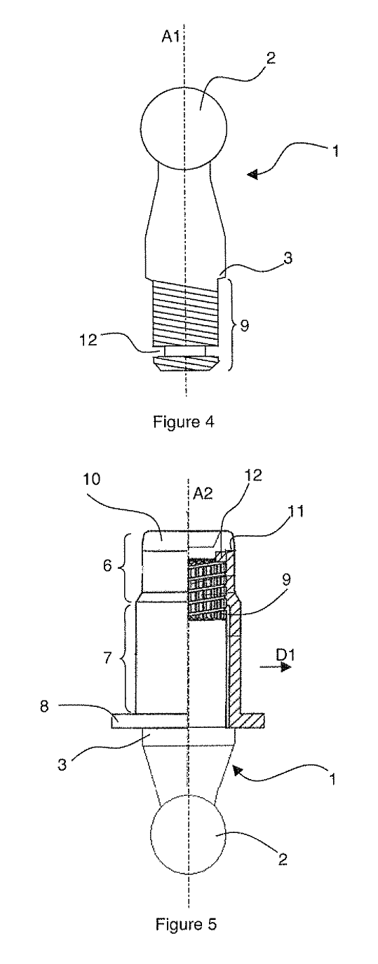

According to a first preferred embodiment, the stem 1, illustrated in FIG. 4, comprises a portion 9, preferably threaded and forming a first thread. This threaded portion 9 is formed along the body of the stem 1 along its longitudinal axis A1, preferably at the second end of the stem 1 opposite the spherical element 2. The assembling area 6, inside the sleeve 5 (FIG. 3), then comprises a second complementary thread. The stem 1 is screwingly mounted onto the sleeve 5 in the assembling area 6. In other words, the first thread of the stem 1 cooperates with the second thread complementary to the sleeve 5 made in the assembly area 6.

The assembling area 6 can be swaged onto the external surface of the sleeve 5. This swaging process allows a work hardening which fixes the stem 1 definitively to the sleeve 5 while favoring the fusion of the first and second threads.

According to a variant form, the stem 1 comprises a threaded portion as indicated above, and the assembling area 9 inside the sleeve 5 is smooth. During the assembly of the stem 1 with the sleeve 5, the sleeve 5 is submitted to a swaging process on its external surface in the assembling area so that the material of the sleeve 5 flows into the thread of the threaded portion of the stem in order to lock the assembly.

The method for manufacturing the device having a spherical element to be crimped consists in manufacturing the stem 1 and the sleeve 5 separately, then in assembling them. Preferably, before their assembly, the sleeve 5 and the stem 1 are treated, in particular by an anti-corrosion surface treatment. The device having a spherical element to be crimped thus obtained is a product ready to be used, which has a good resistance to corrosion, because its two constitutive components, namely the stem 1 and the sleeve 5, were treated separately.

More generally, the assembly can be carried out by inserting the second end of the stem 1 opposite the spherical element 2 through the end of the sleeve 5 comprising the flange 8, then by fixing them to one another in the assembling area 6 by screwing or any other assembling means.

As in FIGS. 3 to 6, the stem 1 can comprise a bearing element 3 between the spherical element 2 and a portion 9 of the body of the stem 1 (portion threaded or not) intended to face the assembling area 6. This bearing element 3 allows advantageously, for a given stem 1 and sleeve 5, to ensure that the assembling area 6 faces the corresponding portion 9 of the stem 1 (FIGS. 3 and 5). Indeed, during the assembly of the stem 1 with the sleeve 5, the bearing element 3 comes into contact with a corresponding bearing area, for example formed by a shoulder inside the sleeve 5 in FIG. 3 or on the bearing flange 8 in FIG. 5, ensuring the correct positioning of the stem 1 with the sleeve 5 for the assembling, for example swaging, process. The embodiment in FIG. 3 will be preferred because it makes it possible to hide the bearing element 3, according to this embodiment the stem can have, from the spherical element 2, a first diameter then a second diameter inferior to the first diameter. The change in diameter allows the bearing on the shoulder of the sleeve.

In fact, the bearing element 3 and the associated bearing area work as alignment means for aligning the sleeve 5 with the stem 1, so that they can be more easily shop-assembled. Consequently, any other alignment means could be used by a person skilled in the art.

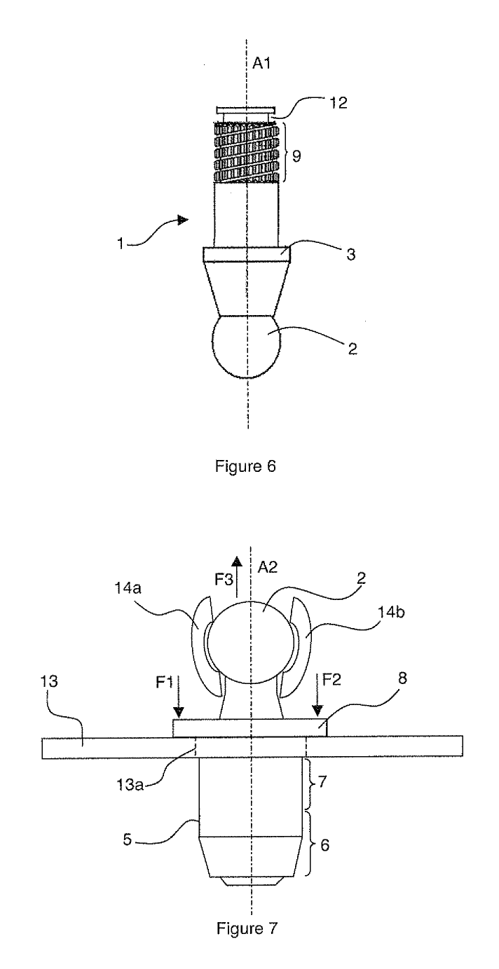

As illustrated in FIGS. 5 and 6 according to a second preferred embodiment, the stem 1 can comprise, on the external surface of its body at the second end of the stem opposite the spherical element 2, a portion 9, preferably knurled and intended to firmly fix the stem 1 to the sleeve 5 in the assembling area 6. The knurled portion 9 comprises a plurality of longitudinal slots preferably parallel to the longitudinal axis A1 of the stem (FIG. 6) and formed on a first thread of the stem 1 so as to form a plurality of helical slots, the first thread cooperating with a second thread of the sleeve 5 formed in the assembling area 6. In FIG. 5, the knurled portion 9 faces the assembling area 6 of the sleeve 5 when the device is assembled, and can be extended under a part of the recessing area 7 of the sleeve 5. This extension can be used for checking the good placement of the stem 1 and the sleeve 5 once assembled. It can be used in combination or not with the alignment means previously described. Preferably, the sleeve 5 and the stem 1 are then definitively fixed to one another by a swaging process.

The function of the helical slots, formed by the characteristic intersection of the thread of the stem 1 and the longitudinal slots, is to optimize the assembly of the sleeve 5 on the stem 1. The longitudinal slots ensures an anti-rotation effect of the sleeve 5 on the stem 1 and the helical slots ensure an anti-extraction effect of the sleeve 5. Thus, the knurled portion 9 ensures a good mechanical resistance of the device once crimped.

According to a variant form of the assembly applicable to the embodiments and their variants, the sleeve 5 is open at its two distal ends along its longitudinal axis A2. The stem 1 is inserted through the bearing flange 8 until its second end, opposite the spherical element 2, projects over the sleeve 5 at the end of said sleeve 5 opposite the flange 8. Then, this second end of the stem 1 can be deformed so as to form a head 10 (FIG. 5) whose dimensions are superior to the dimensions of the section of the sleeve 5, at its end opposite the bearing flange 8, in a plane perpendicular to the longitudinal axis A2 of the sleeve 5. Thus, the head 10 of the stem 1 bears on a supporting surface 11 of the sleeve 5 in the assembling area 6. For example, the supporting surface 11 is formed by the end of the sleeve 5 opposite the bearing flange 8. This head 10 makes it possible to limit the risks of pulling out the stem 1 when or after crimping. The risks of pulling out can still be improved by combining this variant form with the first or the second preferred embodiment, in particular in combination with a swaging process.

In a particular case where the dimensions of the spherical element 2, and a part of the stem 1, are inferior to the internal dimensions of the sleeve 5, i.e. the spherical element 2 and at least a part of the stem 1 can slide freely in the sleeve 5, the second end of the stem 1 opposite the spherical element 2 can comprise a head 10 directly formed when machining of the stem 1. The dimensions of this head 10 are superior to the dimensions of the section of the sleeve 5, at the end of the sleeve 5 opposite the bearing flange 8 and in a plane perpendicular to the axis A2 of the sleeve 5. Thus, the stem 2 can be inserted, on the side of the spherical element 2, into the sleeve 5 through the end of the sleeve 5 opposite the bearing flange 8, until the head 10 bears against a supporting surface 11 of the sleeve 5 in the assembling area 6, and the spherical element 2 projects on the side of the sleeve 5 comprising the flange 8. Consequently, the head 10 of the stem 1 bears on the sleeve 5, limiting the risks of pulling out the stem 1 when or after crimping. The risks of pulling out can still be improved by combining this variant form with the first or the second preferred embodiment, in particular in combination with a swaging process.

According to a variant form of the stem 1 equipped with a head 10 or not, the stem 1 comprises a groove 12 (FIGS. 3 to 6) formed in the stem 1, facing the assembling area 6 and filled with the material forming the sleeve 5. Preferably, if necessary, the groove 12 is formed between the head 10 and the knurled portion (FIG. 5). The function of the groove 12 is to improve the assembly of the sleeve 5 with the stem 1, and to improve the anti-extraction effect of the stem 1, in particular in the event of swaging the sleeve 5. Indeed, swaging the sleeve 5 with the stem 1 in the assembling area 6 makes it possible to drive out the material of the sleeve 5 in the groove 12, which still improves the pull-out resistance of the stem 1 when or after crimping.

In a general way, as mentioned previously, the assembly of the sleeve 5 with the stem 1 is carried out by a swaging process. The sleeve 5 is then crimped by means of two dies on the stem 1 in one or more operations, according to different angles, in order to reduce the external diameter of the sleeve 5 in the assembling area 6. When swaging the sleeve 5 on the stem 1, the material forming the sleeve 5 enters, if necessary, on the one hand the knurled or threaded portion 9, and on the other hand the groove 12 so as to fill them. This makes it possible to work-harden the material in the assembling area 6, the work-hardened material and the particular design of the stem 1 facing the assembling area 6 make it possible to obtain a mechanical assembly which is very resistant when the two components forming of the device are rotating and/or extracted.

The device having a spherical element to be crimped is particularly appropriate to the car industry, in particular for forming ball joint couplings, hinges, or elements that can be snapped into a device having a shape complementary to that of the spherical element 2.

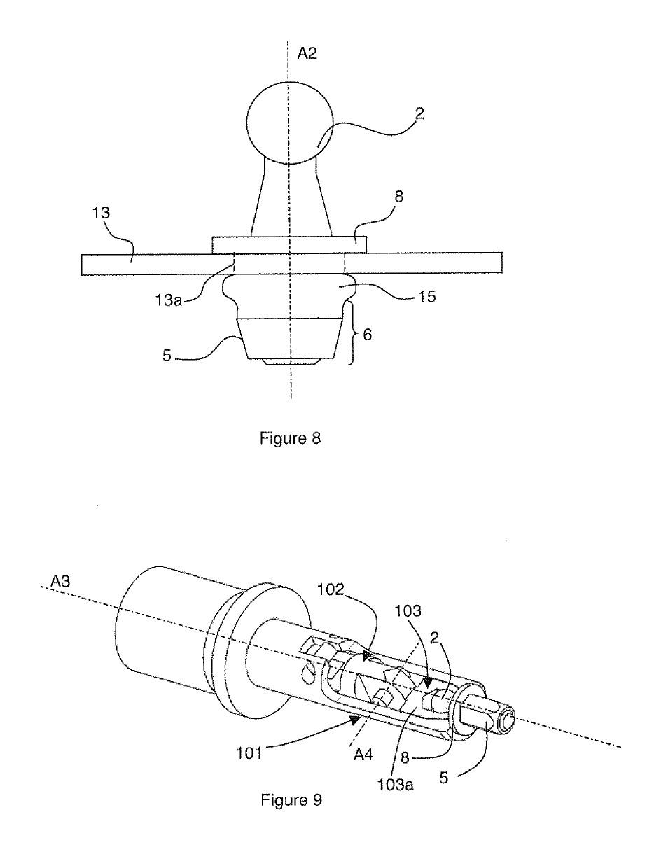

The crimping method for a device having a spherical element to be crimped, as described above, with a support 13 is illustrated in FIGS. 7 and 8. The support 13 comprises a hole 13a, preferably a through hole, into which the device having a spherical element is inserted through its end opposite the spherical element 2 until the bearing flange 8 comes into contact with the support 13. Of course, in order that a supporting surface of the bearing flange 8 can come into contact with the support 13, the hole 13a of the support 13 has dimensions higher than the dimensions of the sleeve 5, except for the bearing flange 8, in a plane perpendicular to the longitudinal axis A2 of the sleeve 5, and dimensions lower than the dimensions of the flange 8 in a plane perpendicular to the longitudinal axis A2 of the sleeve 5. Then, the device having a spherical element can be crimped by applying a holding force (arrows F1, F2) so that the bearing flange 8 presses on the support 13, while applying a traction (arrow F3) to the spherical element 2 so as to deform the sleeve 5 in the recessing area 7 in order to form a crimping bead 15. The force of traction is preferably applied in a direction opposite the holding force. Indeed, the combination of the traction and the holding force will bring the assembling area closer to the support 13 by deformation of the recessing area 7. In other words, the crimping bead 15 has dimensions, in a plane perpendicular to the axis A2 of the sleeve, higher than the dimensions of the hole in the same plane.

As illustrated in FIG. 8, the deformation of the recessing area 7 forms a crimping bead 15, whose function is to maintain the device on the support 13. In other words, the support 13 is maintained between the bead 15 and the bearing flange 8.

The advantageous sphere or ball shape of the spherical element 2 of the stem 1 makes it possible to facilitate the traction exerted on it while using for example a system of jaws 14a, 14b intended to enclose the spherical element 2, in particular at its interface with the remainder of the stem 1. The holding force can be generated by an anvil (not represented) bearing against the bearing flange 8, and pushing the bearing flange 8 towards the support 13 when the force of traction is applied to the spherical element of the stem 1. Preferably, this force of traction is substantially parallel to the longitudinal axis of the sleeve 5.

Preferably, the end of the device intended to be inserted into the hole 13a in the support 13 comprises a chamfer having a substantially truncated shape, also called pilot taper. The chamfer facilitates the introduction of the device into the support.

Such a device and its crimping method allow a crimping process while having access to only one side of the plate.

The stem and the spherical element are monobloc elements from the same material.

Advantageously, as illustrated in FIGS. 3 to 6, the stem 1 comprises a section located between the assembling area and the spherical element and having a shape converging towards the spherical element 2. In fact, this section allows to form a stop during traction in order to limit the crimping process. In other words, the stem comprises, between the assembling area and the spherical element, at least one section formed in such a manner that it operates as a stop during the crimping process so that the stop cooperates with the anvil for stopping the deformation of the sleeve 5. According to an embodiment, the stop can have the shape of an annular projection at the stop section of the stem 1, one face of the projection flushing with one upper face of the bearing flange 8 from where extends a portion of the stem 1 provided with its spherical element 2.

As mentioned above, a crimping system for a device having a spherical element to be crimped and comprising a stem mounted in a sleeve and ending at one end with the spherical element, can advantageously be used in the crimping method. The crimping system enables to position the element spherical in a three-dimensional space in a repeatable and reliable way.

As illustrated in FIG. 9, the crimping system comprises an anvil 101. This anvil 101 is intended to bear on a bearing flange 8 of the sleeve 5. In fact, in FIG. 9, the anvil 101 bears on a face of the flange 8 from where extends the stem provided, at its free end distal from the flange 8, with the spherical element 2.

The crimping system moreover comprises means of traction 102 comprising a system of jaws 103 configured to enclose the spherical element 2. Thus, during the crimping process, the jaws enclose the spherical element 2 so as to hold the stem and exert a traction thereon while the sleeve 5 is maintained in place by means of the anvil 101 bearing on the flange 8.

The term “enclose” means that the jaws surround, at least partially and narrowly, the spherical element so as to contain it. Thus, the shape of the jaws enables to position the spherical element in a repeatable and reliable way.

From the process of crimping a device having a spherical element to be crimped it ensues a problem of insertion of the spherical element. Indeed, the spherical element 2 impedes the insertion of the stem into the crimping system. To solve this problem, the system of jaws comprises at least two jaws which are preferentially articulated to one another.

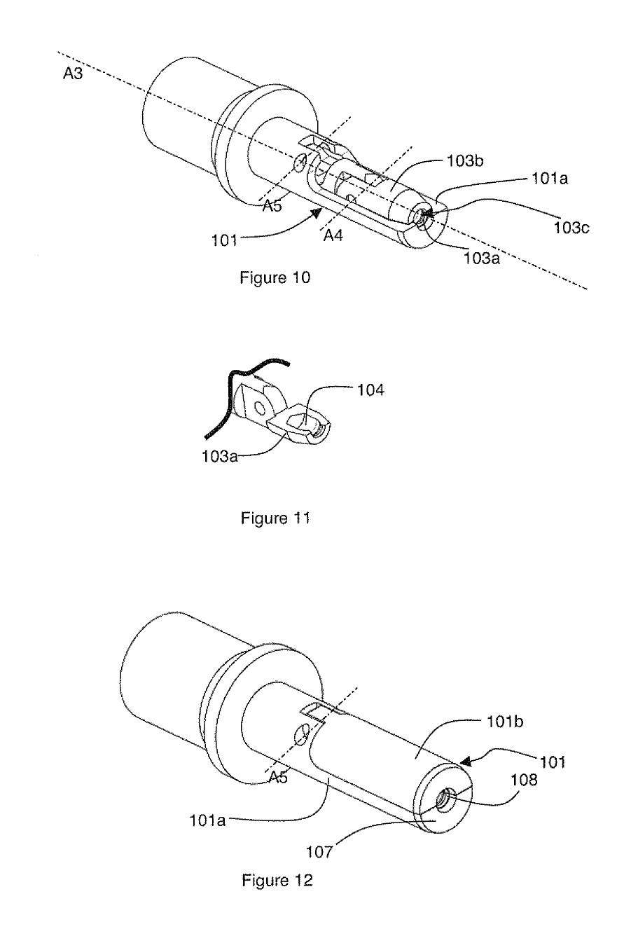

In FIG. 10, the system of jaws comprises two jaws 103a, 103b. In the illustrated example, the two jaws 103a, 103b are in a closed position. Preferentially, in this closed position, a face through which the device to be crimped is introduced comprises an opening 103c dimensioned so as to prevent the withdrawal of the spherical element arranged inside a main cavity delimited by the two jaws and into which opens the opening 103c.

In order to ensure a best hold of the spherical element during the crimping process, each of the two jaws 103a, 103b comprises an open cavity 104 (FIG. 11) formed to follow, at least partially, the outlines of the stem and the spherical element at their junction, the cavities 104 enable the hold of the device to be crimped, by means of its spherical element, in the closed position of the jaws 103a, 10b. Thus, when the jaws 103a, 103b are in the position closed as in FIG. 10, the two open cavities 104 delimit the main cavity mentioned above. In other words, the two open cavities 104 present a partial mold of the spherical element and the stem.

When the jaws are in an open position, the angle formed by the two jaws 103a, 103b is sufficient to enable the insertion of the spherical element between the two jaws 103a, 103b, and when the jaws 103a, 103b are in the closed position the system of jaws comprises the opening 103c dimensioned so as to receive a portion of the stem located between the spherical element and the bearing flange.

Advantageously as illustrated in FIGS. 9 and 10, the two jaws 103a, 103b are mounted so as to rotate A4 with respect to one another in order to define an open position enabling the insertion of the spherical element between the jaws 103a, 103b and a closed position in which the spherical element moves in accordance with the movements of the means of traction 102. Preferentially, return means (not represented) are arranged so as to continuously urge said jaws towards the open position.

The means of traction 102 are preferentially aligned along a longitudinal axis A3. This longitudinal axis A3 also defines the direction of the traction, in FIGS. 9 and 10, it is parallel to the axis of the stem of the device to be crimped. The two jaws are installed so as to rotate about an axis A4 substantially perpendicular to the axis A3.

Preferentially, in order to make a compact and efficient crimping system, the means of traction are translatingly mounted in the body of the anvil 101 which then forms a sleeve making it possible to guide the jaws during traction. In FIG. 12, the body of the anvil 101 then comprises preferentially a fixed part 101a and a movable part 101b, swivelingly mounted A5 on the fixed part 101a, whose open and closed positions coincide respectively with the open and closed positions of the two jaws 103a, 103b (FIG. 10). In fact, when no force is applied to the anvil, the return means enable the hold of the jaws in the open position, the jaw 103b swivelingly mounted on the jaw 103a is in contact with the movable part 101b of the anvil and the forces exerted by the return means are transmitted to the movable part 101b so as to maintain it with the anvil in the open position.

The swivel pin A5 in FIG. 12 is also represented in FIG. 10. In FIG. 10, this swivel pin is parallel to the swivel pin A4 of the jaws.

As illustrated in FIG. 12, the jaws (not represented) and the anvil 101 are in a closed position. In this closed position, the end face 107 of the anvil coming in contact with the bearing flange 8 (FIG. 9) comprises an opening 108 enabling the stem to slide when the traction force is applied to the spherical element by the means of traction. This opening 108 is coaxial with the opening 103c of the jaws mentioned above. The opening 108 can be dimensioned so as to cooperate with the stop section of the stem mentioned above. Thus, the stop section comes into contact with the anvil during traction. The traction moment exerted by the means of traction is calculated so that, when the stop section bears on the anvil, the traction either is stopped, or is not sufficient any more to deform the sleeve of the device to be crimped in the recessing area.

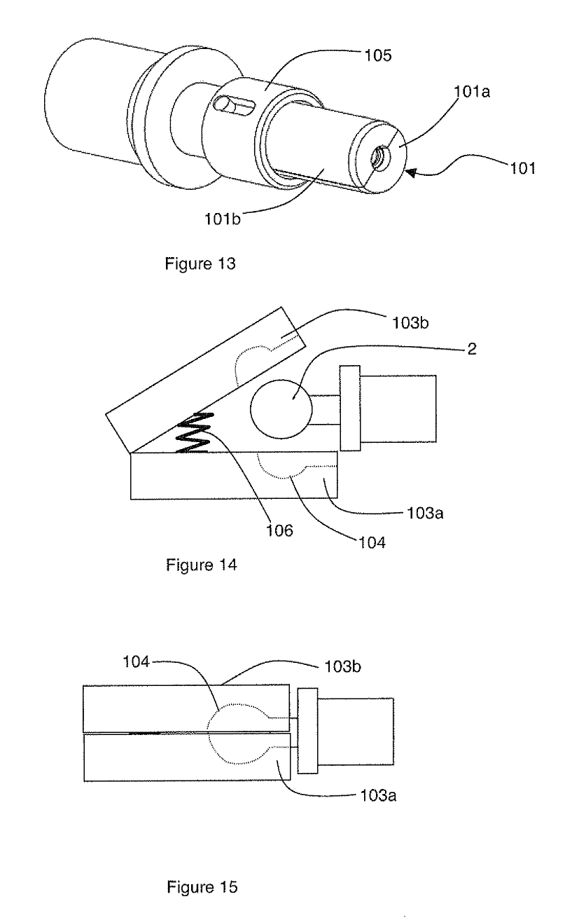

To facilitate the closing of the jaws 103a, 103b and of the anvil 101, there exists a need for locking, if necessary, the return means in order to make the jaws 103a, 103 and the fixed and movable parts 101a, 101b switch into the closed position. This need can be fulfilled by providing, as in FIG. 13, a locking element 105 translatingly mounted on the outside of the body of the anvil 101. The locking element 105 includes a disengaged position in which the jaws and the anvil 101 (via its fixed and movable parts) are in the opened position, and an engaged position (FIG. 13) closing again the movable part 101b of anvil 101 onto its fixed part 101a so that the movement of closing the anvil is transmitted to the jaws in order to put them into the closed position by compressing the return means. In fact, as the movable part 101b is swivelingly mounted on the fixed part 101a, when switching from the disengaged position to the engaged position the locking element 105 bears on these two parts so that the movable part 101a is closed onto the fixed part 101b.

According to an embodiment of the return means illustrated in FIG. 14, these return means comprise a spring 106 whose ends respectively bears on the jaws 103a, 103b, preferentially in an associated open cavity. It can be a compression spring 106 whose free length is sufficient to open the jaws 103a, 103b so as to enable the insertion of the spherical element 2 between said jaws 103a, 103b. In FIG. 14 the jaws 103a, 103b are in the open position and in FIG. 15 the jaws 103a and 103b are in the closed position. In FIGS. 14 and 15, the open cavities 104 described above are represented in dotted lines.

In addition to the jaws, the means of traction can comprise a traction stem integral with the jaws and a motor configured to translate the stem.

According to an alternative, the system of jaws comprises a plurality of jaws arranged in the form of segments able to open radially. This notably enables to adapt the system of jaws to various diameters of spherical elements.

1. Crimping system for a device having a spherical element to be crimped comprising a stem mounted in a sleeve and ended at one end with the spherical element, said crimping system comprises:
an anvil intended to bear on a bearing flange of the sleeve,
means of traction comprising a system of jaws configured to enclose the spherical element.

2. Crimping system according to claim 1, wherein the system of jaws comprises two jaws.

3. Crimping system according to claim 2, wherein both jaws comprises an open cavity formed to follow, at least partially, the outlines of the stem and the spherical element at their junction, the cavities enabling the hold of the device to be crimped in a closed position of the jaws.

4. Crimping system according to claim 3, wherein the two jaws are swivelingly mounted one above the other in order to define an open position enabling the insertion of the spherical element between the jaws and a closed position in which the spherical element moves in accordance with the movements of the means of traction, and in that return means are arranged to continuously urge said jaws towards the open position.

5. Crimping system according to claim 4, wherein the means of traction are translatingly mounted in the body of the anvil.

6. Crimping system according to claim 4, wherein the body of the anvil comprises a fixed part and a movable part swivelingly mounted on the fixed part, whose open and closed positions coincide respectively with the open and closed positions of the jaws.

7. Crimping system according to claim 6, wherein a locking element is translatingly mounted on the outside of the body of the anvil, the locking element including a disengaged position in which the jaws and the fixed and movable parts of the anvil are in the opened position, and an engaged position closing again the movable part of the anvil on its fixed part so that the movement of closing the anvil is transmitted to the jaws in order to switch them in the closed position by compressing the return means.

8. Crimping system according to claim 4, wherein the return means comprise a spring whose ends respectively bear on one of the two jaws.

9. Device having a spherical element to be crimped comprising a stem ending at a first end with the spherical element,
said device comprising a sleeve into which the stem is inserted, said sleeve including successively along its longitudinal axis:
an assembling area for assembling the sleeve on the stem,
a recessing area intended for the formation of a crimping bead, and
a bearing flange, the spherical element of the stem projecting at the bearing flange.

10. Device according to claim 9, wherein the stem comprises a first thread at a portion of said stem cooperating with a second thread complementary to the sleeve in the assembling area.

11. Device according to claim 10, wherein opposite the assembling area the portion is knurled, the knurl being provided with a plurality of longitudinal slots made on the first thread of the stem so as to form a plurality of helical slots.

12. Device according to claim 9, wherein the stem comprises a head at a second end of the stem opposite the first end of the stem, the head bearing on a supporting surface of the sleeve in the assembling area.

13. Device according to claim 9, wherein the stem comprises a groove formed in the stem, facing the assembling area and filled with a material forming the sleeve.

14. Device according to claim 9, wherein the assembling area is swaged.

15. Device according to claim 9, wherein the stem and the sleeve are assembled in the assembling area by welding, friction fitting or snap riveting the sleeve.

16. Crimping method for crimping a device having a spherical element according to claim 9 with a support comprising a hole, said crimping method comprising the following steps of:
inserting the device having a spherical element into the hole in the support, through its end opposite the spherical element until the bearing flange comes into contact with the support,
crimping the device by applying a holding force so that the bearing flange presses on the support, while applying a traction to the spherical element so as to deform the sleeve in the recessing area in order to form a crimping bead.
